(19) United States
(12) Patent Application Publication
(10) Pub. No.: US 2007/0098838 A1
(43) Pub. Date: May 3, 2007

(54) Injection molding machine for producing shaped plastic parts, preferably plastic cups

(75) Inventor: Walter Dobler, Bad Urach-Seeburg (DE)

Correspondence Address: GUDRUN E. HUCKETT DRAUDT, LONSSTR. 59, WUPPERTAL, 42289, DE

(73) Assignee: SysTec Komplettsysteme GmbH, Bad Urach (DE)

(21) Appl. No.: 11/549,144

(22) Filed: Oct. 13, 2006

(30) Foreign Application Priority Data
Oct. 14, 2005 (DE) 10 2005 050 027.7

(51) Int. Cl. B29C 45/42

(52) U.S. Cl. 425/556; 425/444

(57) ABSTRACT

An injection molding machine for producing shaped plastic parts has at least one injection mold and at least one removal unit with which shaped plastic parts are removed from the at least one injection mold. The shaped plastic parts are put down in a controlled way while the at least one injection mold is in a closed position. At least one putting-down unit is provided and the at least one removal unit transfers the shaped plastic parts to the at least one putting-down unit. The putting-down unit places the shaped plastic parts into at least one receptacle.

### BACKGROUND OF THE INVENTION

The invention relates to an injection molding machine for producing shaped plastic parts, preferably plastic cups, according to the preamble of claim 1.

In connection with manufacturing plastic cups, it is known that, after opening the injection mold, the plastic cups are removed by a removal unit and then blown off so that the plastic cups drop from the removal unit downwardly into stacking units. This can cause the plastic cups to become damaged, in particular when they have thin walls. Since the plastic cups are very lightweight, handling causes significant problems so that a safe production is not ensured.

### SUMMARY OF THE INVENTION

The invention has the object to configure an injection molding machine of the aforementioned kind such that the shaped plastic parts produced in the injection mold can be reliably manipulated by means of the removal unit.

This object is solved for an injection molding machine of the aforementioned kind in accordance with the present invention by the characterizing features of claim 1.

In the injection molding machine according to the invention, the shaped plastic parts produced in the injection mold are removed by the removal unit and put down in a controlled way. This putting down step is realized when the injection mold is closed again and the next shaped plastic part is injection molded. On the one hand, the shaped plastic parts are safely put down and, on the other hand, the time for removal of the shaped plastic parts is not impaired by this putting down step. The putting down step is significantly shorter than the time for injection molding the next shaped plastic part. In this way, it is ensured that when opening the injection mold the removal unit is already in the required position for removal of the shaped plastic part.

Further features of the invention can be taken from the additional claims, the description, and the drawings.

### BRIEF DESCRIPTION OF THE DRAWINGS

The invention will be explained in the following with the aid of two embodiments illustrated in the drawings. It is shown in:

FIG. 1 partially in plan view and partially in section an injection molding machine according to the invention for producing plastic cups;

FIG. 2 a plan view onto a transfer unit for labels of the injection molding machine according to the invention;

FIG. 3 a stacked injection mold of a second embodiment of an injection molding machine according to the invention in the closed position;

FIG. 4 a side view of the injection mold according to FIG. 3;

FIG. 5 in an illustration in accordance with FIG. 3 the injection mold in the open position;

FIG. 6 a plan view onto a part of the second embodiment of the injection molding machine according to the invention;

FIG. 7 in a schematic illustration the movement course of a removal unit and an insertion unit of the injection molding machine according to the invention according to FIGS. 1 and 2;

FIG. 8 in a schematic illustration the removal of an injection molded plastic cup from the open injection mold as well as insertion of a label for the next injection molding step;

FIG. 9 in an enlarged and schematic illustration the insertion unit and the removal unit of the injection molding machine according to the invention;

FIG. 10 a second embodiment of a removal unit and an input unit of the injection molding machine according to the invention.

### DESCRIPTION OF THE PREFERRED EMBODIMENTS

The injection molding machine is used for injection molding plastic cups that are provided with at least one label that is fixedly connected to the plastic material. The labels are provided in at least one magazine 1 of the injection molding machine in which they are arranged behind one another and/or atop one another. They are removed by means of at least one transfer unit 2 from the magazine 1 and transferred to an insertion unit 3 with which the labels are placed into the injection mold 4. In order to achieve a high output of the injection molding machine, several magazines 1 and accordingly several transfer units 2, insertion units 3, and one injection mold 4 with several cavities are provided. With such an injection molding machine, not only plastic cups but also other shaped plastic parts, for example, lids, tubes, and the like can be produced. The labels are preferably printed and can be comprised of plastic film, metal foil, multi-layer films and the like.

The magazines 1 are preferably inclined so that the labels contained therein will safely slide down and can be picked up by the transfer unit 2. Such label magazines 1 are known and are therefore not explained in detail.

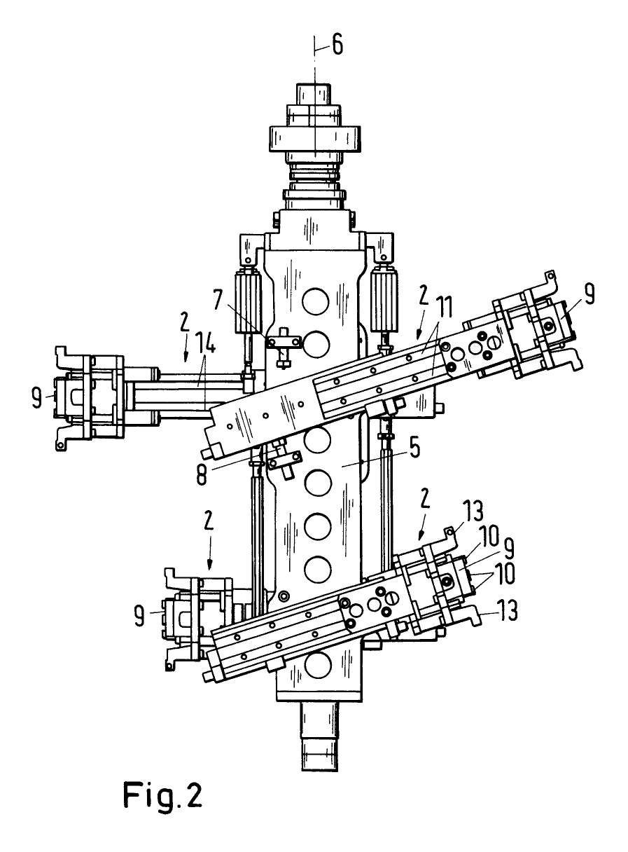

The transfer units 2 are provided on the vertical stand 5 (FIG. 2) that is rotatably supported about vertical axis 6 in the injection molding machine. The transfer units 2 are arranged on the stand 5 so as to be pivotable to a limited extent about a horizontal axis. FIG. 2 shows two transfer units 2 in an inclined position and two additional transfer units 2 in a horizontal position. Both positions are determined by stops 7, 8 provided on the stand 5 and formed in the embodiment by adjusting screws. The transfer units 2 are positioned in their respective end position against the screw heads. By means of the adjusting screws, the position of the transfer units 2 can be adjusted simply and precisely. The transfer units 2 are identical and have each a receiving part 9 in the form of a suction holder with which the label 12 is removed from the magazine 1. The receiving parts 9 are provided at the end face with vacuum openings 10 by means of which vacuum can be generated for removing each label from the magazine 1. Each label sticks to the end face of the receiving part 9 and can be transferred in a way to be described in the following to the insertion unit 3. The receiving parts 9 are movable in the axial direction of the transfer unit 2.

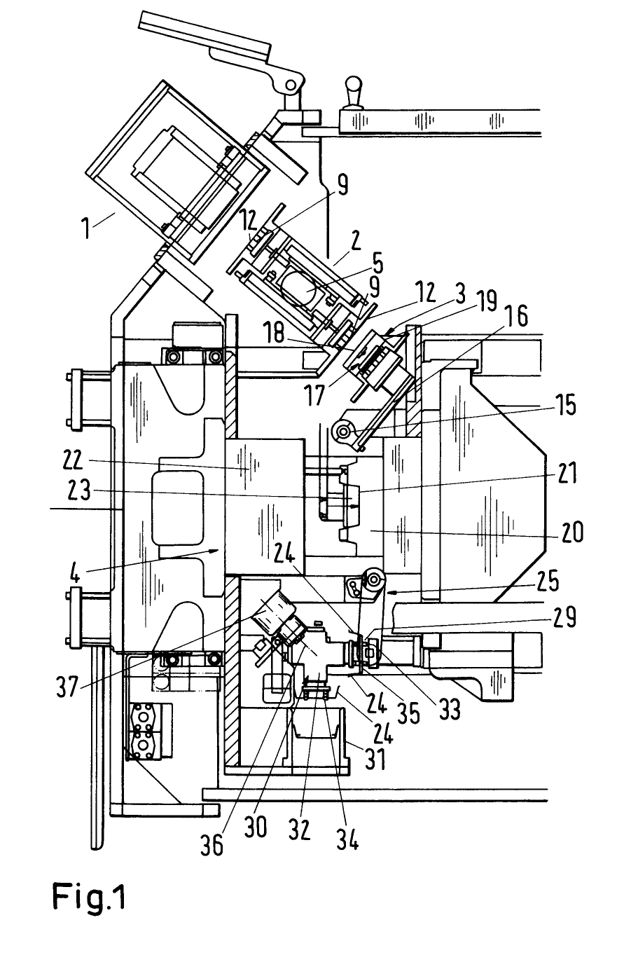

On opposite sides of the stand 5, two transfer units 2 are positioned that are spaced from one another. In FIG. 2 the receiving part 9 of the upper transfer unit 2, respectively, is in the extended position while the receiving part 9 of the lower transfer units 9 are retracted. Since the magazine 1 is inclined, the transfer units 2 are moved into the slanted position shown in FIG. 2 in which at least the axis of the receiving parts 9 is positioned on an extension of the axis of the magazine 1. For receiving the labels 12, the receiving parts 9 are extended so that they can pick up the leading label, respectively, from the magazines 1 by generating vacuum. Subsequently, the stand 5 is rotated about vertical axis 6 such that the receiving parts 9 with labels 12 are located opposite the insertion units 3. During rotation of the stand 5, the two transfer units 2 are pivoted about the horizontal axis so far that they assume the horizontal position, defined by the stops 7, and then transfer the labels 12 safely to the insertion units 3. The transfer units 2 located on the other side of the stand 5 are pivoted during the rotational movement of the stand 5 out of their horizontal position into the slanted position that is determined by the stops 8. While the first transfer units 2 transfer their labels 12 to the insertion units 3, the two second transfer units 2 pick up the next labels from the magazines 1. Depending on the position of the magazines 1 and of the insertion units 3 in the injection molding machine, it can be required to extend and retract the receiving parts 9 during the rotational movement of the stand 5. In FIG. 1, the labels 12 that are held by the receiving parts 9 of the transfer units 2 by vacuum are illustrated in an exemplary way. The labels 12 are plane and are supported reliably on the receiving parts 9. As shown in FIG. 2, the receiving parts 9 have laterally adjacent to the vacuum openings 10 plane contact surfaces 13 for the labels 12. Depending on the configuration of the labels 12, it is possible to provide on the transfer units 2 correspondingly designed receiving parts 9 that, for this purpose, are arranged on the transfer units 2 advantageously so as to be easily exchangeable. The receiving parts 9 are positioned advantageously on rods 14 that are guided in the transfer units 2 and are preferably pneumatically loaded in order to be moved.

The insertion units 3 are positioned on a vertical shaft 15 (FIG. 1) which is supported rotatably in the injection molding machine and on which the insertion units 3 are positioned atop one another at a spacing. In the embodiment, on the pivot shaft 15 two insertion units 3 are positioned above one another at a spacing. The insertion units 3 are advantageously identical and have an arm 16 projecting transversely away from the shaft 15; the arm has at its free end a receiving head 17 for the label 12. In the illustrated embodiment, the receiving head 17 is of parallelepipedal shape and has slots (not illustrated) through which a vacuum force is applied onto the label 12. It is then automatically wound onto the receiving head 17 in a cup shape. The receiving head 17 has an end face 18 as well as sidewalls 19 on which the label 12 rests areally as a result of the vacuum force.

For receiving the labels 12 from the transfer units 2, the insertion unit 3 is in the transfer position illustrated in FIG. 1. The receiving parts 9 that secure the labels 12 by vacuum are extended after rotation of the stand 5 into the transfer position according to FIG. 1 to such an extent that the labels 12 first come to rest against the end face 18 of the receiving heads 17 or are spaced minimally therefrom. Subsequently, the label is blown off by the receiving part 9 of the transfer units 2 and shortly beforehand vacuum is applied to the receiving heads 17 of the insertion units 3. In this way, a safe transfer of the label 12 from the transfer units 2 to the insertion units 3 is ensured. Directly after the transfer of the labels 12 has taken place, the receiving parts 9 of the transfer units 2 are retracted. At the same time, the other transfer units 2 that have removed the label 12 from the respective magazine 1 are also retracted. When rotating the stand 5 about the vertical axis 6, all of the receiving parts 9 are thus in the retracted position. As soon as the receiving parts 9 are again positioned opposite the magazines 1 or the insertion units 3, they are extended. While on one side the labels 12 are transferred to the insertion unit 3, on the opposite side the labels 12 are removed from the magazine 1.

In the embodiment the magazines 1 and the insertion units 3 are positioned opposite one another so that the stand 5 is rotated by 180 degrees, respectively. Depending on the configuration of the injection molding machine, the magazines 1 and the insertion units 3 can have other positions relative to one another so that the stand 5 accordingly rotates about different angles. The shaft 15 of the insertion units 3 is fixedly connected to the movable mold part 20 of the injection mold 4 so that the shaft 15 upon opening and closing of the injection mold 4 is entrained by the mold part 20. The mold part 20 is movable horizontally within the injection molding machine and provided with a female mold 21 into which, in a way to be described in the following, the label 12 is inserted by the receiving head 17. The mold part 20 has positioned opposite thereto the mold part 22 with male mold 23. The female mold 21 and the male mold 23 together form the mold for producing the plastic cup. The mold part 22 is fixedly connected to the machine while the mold part 20 is moveable for opening and closing the mold 4.

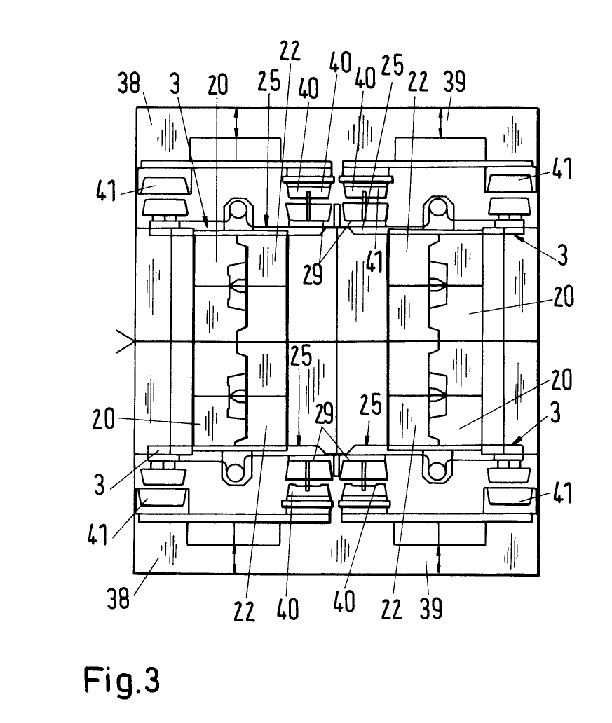

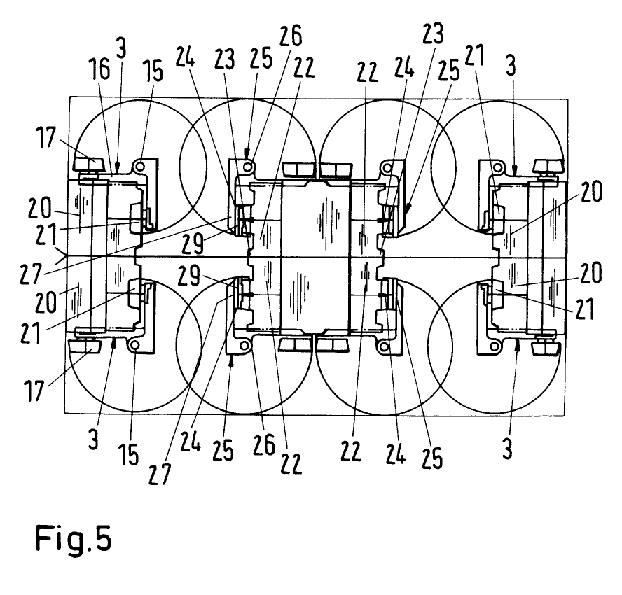

FIG. 3 shows an injection mold 4 of a second embodiment of an injection molding machine. The injection mold 4 is of a stacked mold configuration in which several mold parts 20,22 are provided. In the embodiment, four mold parts 20,22 each are provided so that in the injection molding machine four plastic cups are simultaneously injection molded. The four injection molds according to FIG. 3 are arranged adjacent and atop one another. In accordance with the number of injection molds there is also a corresponding number of insertion units 3 and transfer units 2 provided on the injection molding machine. As shown in FIGS. 3 and 5, the adjacently positioned mold parts 20 and 22 are monolithic so that upon opening of the injection molds (FIG. 5) two injection-molded plastic cups can be removed simultaneously. As shown in FIG. 5, on the oppositely positioned sides of the mold part 20 a shaft 15 is provided on which two insertion units 3 above one another are fixedly supported, respectively. With them, the labels 12 can be inserted into the female molds 21 of the mold parts 20 when the injection mold is open. The receiving heads 17 are matched to the shape of the female molds 21. In an exemplary way, FIG. 5 shows the transfer position outside of the injection mold for the insertion units 3 and the insertion position in which the insertion units 3 insert the label 12 by means of the receiving heads 17 into the female molds 21. In the female molds 21 the respective label 12 is secured in a way known in the art until the injection mold 4 is closed again. As soon as the receiving head 17 of the insertion unit 3 is immersed into the female mold 21, the vacuum source is switched off or the wound label 12 is blown off so that it reaches the female mold 21. Subsequently, the injection mold 4 can be closed and the plastic material can be injection molded about the label. When the injection mold 4 is open again, the injection-molded plastic cup 24 is seated on the respective male mold 23. From this position, it can be removed by a removal unit 25 in a way to be described in the following.

In the embodiments according to FIGS. 1, 2, 7, and 8, the removal unit 25 is rotatable about a vertical axle 26 that is fixed to the machine. Depending on the number of injection molds 4 or of the number of plastic cups 24 produced therein, several removal units 25 are arranged above one another on the axle 26. At the upper and lower ends of the axle 26, a radially projecting arm 27 is provided, respectively, that supports an axle 28 at its free which axle is positioned parallel to the axle 26. Suction holders 29 are seated thereon with which the injection-molded plastic cups 24 seated on the male molds 23 can be removed. On the arms 27, a rotary drive (not illustrated) for the axle 28 positioned parallel to the axle 26 is arranged. With it, the axle 28 upon rotation of the axle 26 is rotated relative to this axle such that the plastic cup 24 and thus the vacuum holder 29 are moved translatorily; see FIG. 8.

The insertion units 3 and the removal units 25 are positioned on opposite sides of the injection mold 4 wherein the removal units 25 are fixed to the machine while the insertion units 3 together with the movable mold part 20 are entrained upon opening and closing the injection mold.

As is shown in FIG. 8, by means of the removal units 25 the plastic cups 24 seated on the male molds 23 are removed while at the same time the labels 12 are inserted for the next injection molding step into the female molds 21 by means of the insertion units 3. The insertion units 3 are rotated in the described way for the insertion process about shaft 15 that extends parallel to the axle 26 of the removal units 25. The rotary movement of the axles 15, 26 is coordinated such that the insertion units 3 and the removal units 25, when the injection mold is open, do not collide with one another. Advantageously, the rotational movements of the axles 15, 26 are coupled by a sequence control such that first the removal units 25 are pivoted into the open injection mold and, by means of the vacuum holders 29, the plastic cups 24 are removed from the male mold 23. With time delay the insertion units 3 are pivoted from the transfer position according to FIG. 1 into the open injection mold in order to insert the labels 12 seated on the receiving head 17 into the female mold 21. Subsequently, the insertion units 3 pivot back into the transfer position according to FIG. 1 in order to receive the next labels 12 from the transfer units 2.

Removal of the plastic cups 24 and insertion of the labels 12 into the female molds 21 for the next injection molding process is realized essentially simultaneously. In this way, in a unit of time a very large number of plastic cups can be injection molded. Since the insertion units 3 and the removal units 25 are pivoted at the same time into the open injection mold 4 and are immediately thereafter moved out again, the time between sequentially performed injection molding processes can be kept very short.

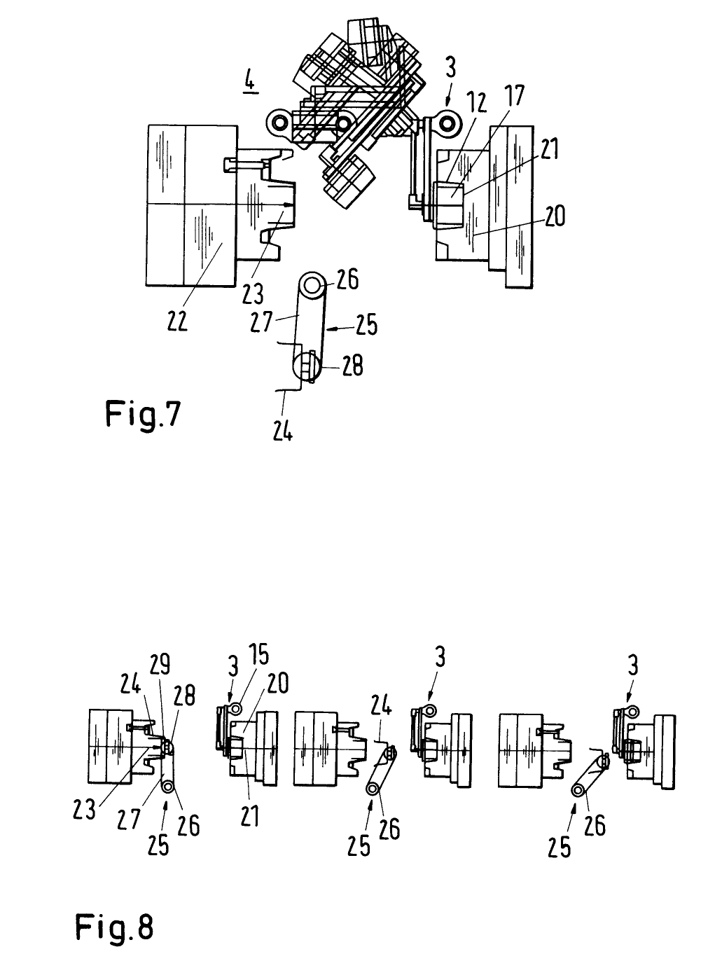

FIG. 7 shows the movement course of the insertion unit 3 from the time of opening the injection mold until insertion of the label 12 seated on the receiving head 17 into the female mold 21. FIG. 8 shows how the plastic cup 24 is moved translatorily by means of the removal unit 25 in that the axle 28 during the pivoting action is rotatably driven relative to the axle 26. The end position of the removal units 25 is shown in FIG. 7 in which the arm 27 is completely outside of the injection mold 4.

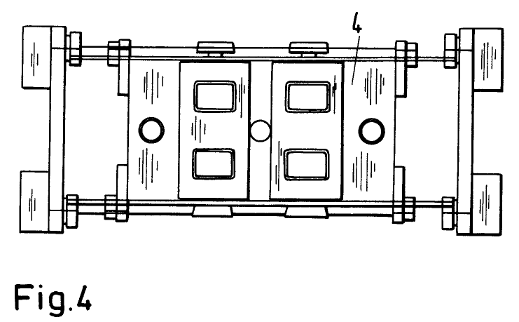

In the embodiment according to FIG. 3 to FIG. 6, the insertion units 3 pivot about a substantially larger angle than in the embodiment according to FIGS. 1, 3, and 7. In the latter embodiment, the pivot angle between transfer position and insertion position is smaller than 180 degrees. In the embodiment according to FIGS. 3 to 6 this pivot angle is 270 degrees. In the transfer position the arms 16 of the insertion units 3 are positioned on one side of the mold parts 20. Since in the illustrated embodiment according to FIGS. 3 to 6, each mold part 20 has two female molds 21, on the sides facing away from one another each mold part 20 is provided with an insertion unit 3, respectively.

The removal units 25 correlated with the male molds 23 are rotatable from the initial position by 270 degrees into the removal position about the axle 26. In contrast to the preceding embodiment, on the free end of a transversely projecting arms 27 of the removal units 25 no further axle is provided. Instead, on the free end of the arm 27 the vacuum holder 29 that removes the injection-molded plastic cup from the respective male mold 23, respectively, is fixedly attached. In FIG. 5, the pivot travel of the insertion units 3 and the removal units 25 is indicated. Since the movement travel of these units overlap one another partially, the pivot movement of the units 3, 25 is controlled such that they do not collide with one another. In this embodiment, the injection-molded plastic cups 24 are also removed from the open injection mold and substantially simultaneously the labels for the next injection molding process are inserted. As soon as the units 3, 25 are again in their initial position, the injection mold 4 is closed and the next injection molding process is initiated.

The plastic cups 24 removed from the injection molds by the removal units 25 are transferred onto putting-down units 30 with which the plastic cups 24 are positioned into a receptacle 31 in a controlled way. The putting-down unit 30 has two arms 32, 33 positioned at a right angle relative to one another and provided at their free ends with suction holders 34, 35. In the embodiment, the arms 32, 33 are positioned in a horizontal plane. The putting-down unit 30 can be rotated about an axle 36 by 180 degrees; the axle extends at 45 degrees between the arms 32, 33 and is positioned in the plane of the arms 32, 33. This has the result that after pivoting about 180 degrees the arms 32, 33 have changed places.

The putting-down unit 30 in its initial position is arranged such that the suction holder 35 of the arm 33 is positioned opposite the suction holder 29 of the removal unit 25 (FIG. 1). When the removal unit 25 pivots into the position illustrated in FIG. 1, the suction holder 35 engages the removed cup 24. It is blown off the suction holder 29 of the removal unit 25 and secured on the suction holder 34 of the putting-down unit 30 by applying vacuum. Subsequently, the putting-down unit 30 is pivoted about axle 36 by means of drive 37 so that the plastic cup 24 is opposite the receptacle 31. Subsequently, the suction holder 35 with the plastic cup 24 arranged thereat is extended and in this way the plastic cup 24 is inserted into the plastic cup 24 which is already within the receptacle 31. In this way, in the receptacle 31 a stack of plastic cups 24 inserted into one another is formed. The suction holders 34, 35 are positioned on the rods (not illustrated) that can be extended from the respective arms 32, 33.

While the plastic cups 24 are inserted into the receptacle 31, the next plastic cup is removed at the same time by the removal unit 25 by means of the suction holder of the other arm. In this way, by switching back and forth the putting-down unit 30 the plastic cup removed from the injection mold 4 can be inserted into the receptacle 31. It is horizontal. As soon as the receptacle 31 has formed the required stack length of plastic cups 24, the stack is pushed out of the receptacle 31 and placed onto a conveyor belt or the like with which the plastic cup stack is transported farther to be packaged.

Depending on the number of injection molds and removal units 25 a corresponding number of putting-down units 30 and receptacles 31 is provided. With the injection molding machine several plastic cup stacks can thus be formed in a unit of time. In the embodiment according to FIG. 3 to 6, between the removal unit 25 and the putting-down unit 30 a linear unit 38, 39 is interposed. They have suction holders 40, 41 with which the plastic cups 24 can be picked up from the removal units 25 and the labels 12 can be inserted into the insertion units 3. For this purpose, the plastic cups 24 are blown off the suction holders 29 of the removal units 25 and are attracted by the suction holders 40. Subsequently, the linear units 38, 39 are moved in the direction of the movement arrows indicated in FIG. 3 until the suction holders 40 are located in the transfer area of the putting-down unit 30. Here, the plastic cups 24 are received in the described way by the putting-down units 30 and inserted into receptacles 31.

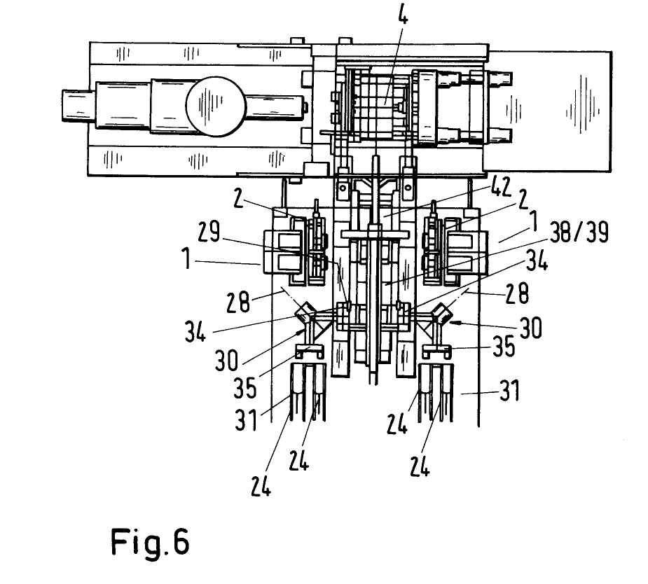

In this embodiment, the magazines 1 for the labels are arranged on both sides of the linear units 38, 39. Between them and the magazines 1 the transfer units 2 are arranged (FIG. 6) with which the labels are removed from the magazine 1, respectively, and transferred to the corresponding suction holders 41 of the linear units 38, 39. As shown in FIG. 3, while the injection mold 4 is closed, by means of the suction holders 40, 41 the labels 12 are transferred to the insertion units 3 and, at the same time, the plastic cups 24 are removed from the removal units 25. The labels 12 are wound in a cup shape, as in the injection molding machine according to FIGS. 1 and 2, about the suction holder 41 by suction air.

As shown in FIG. 6, in the movement direction on both sides of the linear units 38, 39 suction holders 40, 41 are provided. The linear units 38, 39 are moved into the transfer position illustrated in FIG. 6 in which the plastic cups 24 secured by vacuum on the suction holders are transferred to the putting-down units 30. The suction holders 34, 35 of the putting-down units 30 are configured such that simultaneously two plastic cups 24 can be received from the linear units. The plastic cups 24 that are seated on the suction holders of the linear units 38, 39 are blown off for transfer to the putting-down units 30 and by means of vacuum secured on the suction holders 34 or 35. Subsequently, the putting-down units 30 are rotated about axle 28 by 180 degrees so that the plastic cups 24 on the suction holders 34, 35 are positioned opposite the receptacles 31. The suction holders 34, 35 are extended in order to move the plastic cups 24 into the receptacles 31. At the same time, by means of the suction holders of the other arm of the putting-down units 30, the next plastic cups are removed from the removal units 25 in the described way. By pivoting the putting-down units 30 about the inclined axles 28, the plastic cups 24 are stacked within a very short period of time in the receptacles 31.

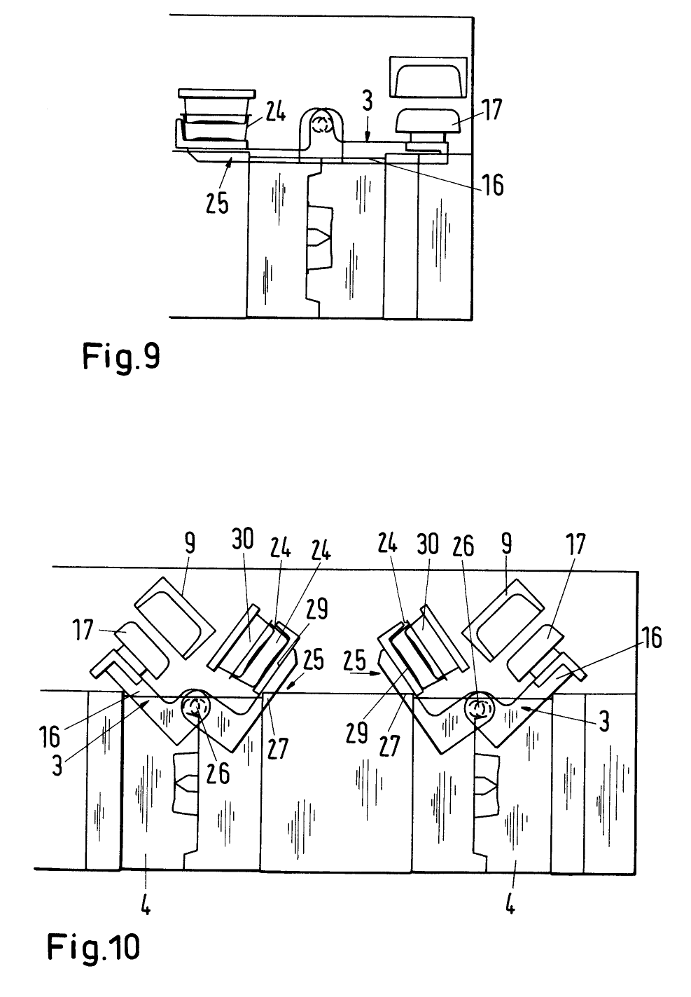

As shown in FIG. 10, the insertion unit 3 and the removal unit 25 in the initial position can also be arranged at an angle of approximately 90 degrees relative to one another. The insertion units 3 have the receiving head 17 provided at the free end of the arm 16 which receiving head receives the label to be inserted into the injection mold 4 in the way described above. It is transferred by means of the receiving part 9 of the transfer unit 2. In accordance with the embodiment of FIGS. 3 to 5 and 9, the removal units 25 have the arm 27 that projects transversely from the axle 26 and is provided at its free end with the suction holder 29 for removing the finished plastic cup 24. It is transferred to the putting-down unit 30 in the described way that is illustrated only partially in FIG. 10.

The injection molding machine has a high output because by means of the stand 5 and the transfer units 2 provided on both sides the removal of the labels 12 from the magazine 1 and the transfer to the insertion units 3 is performed simultaneously. The transfer units 2 or their receiving parts 9 must perform only a very short stroke in order to transfer the labels 12 to the receiving heads 17 of the insertion units 3. The label transfer is therefore performed very quickly. The receiving heads 17 of the insertion units 3 are provided about their circumference with slots (not illustrated) by means of which the suction air can act on the labels 12. By applying vacuum, the labels 12 are automatically wound in a cup shape onto the receiving heads 17.

When the receiving units 25 are embodied in accordance with FIGS. 1, 2, 7, and 8, there is a very simple and quick transfer of the injection-molded plastic cups 24 to the putting-down units 30. When the injection molding machine has several injection molds, for example 4 or 6, then a corresponding number of magazines 1, transfer units 2, insertion units 3, removal units 25, and putting-down units 30 as well as receptacles 31 are provided. The molded parts 20, 22 are exchangeable so that a format change of the plastic cups can be done simply and quickly. By means of the putting-down units 30 the plastic cups 24 are reliably inserted into the receptacles 31 so that they can be stacked trouble-free in the receptacles 31. When several plastic cups 24 are transferred simultaneously and inserted into the receptacles 31, within a unit of time a very large number of plastic cups can be produced. The injection molding machine in this connection is very compact so that it can be installed even when tight space conditions are present. The described movements of the individual units of the injection molding machine are possible without plane-motion direct-contact mechanism only by means of servo motors or path control. The described winding technology, i.e., winding of the labels 12 onto the receiving heads 17 by applying vacuum, is suitable also for deep-drawing plastic cups. Insertion of the plastic cups 24 into the receptacles 31 is realized parallel to the injection molding process of the next plastic cups 24 so that a targeted stacking of the plastic cups 24 and injection molding of new the plastic cups can be performed simultaneously. In a configuration of the injection molding machine in accordance with FIGS. 1, 2 and 7 through 9, very short cycle times result. For insertion of the labels and the essentially simultaneous removal of the plastic cups 24, the injection mold must be opened only for a very short period of time. The opening time of the injection mold is within a magnitude of approximately 0.2 to 0.4 seconds. This opening time of the mold is thus significantly reduced in comparison to injection molding machines with a linear system in which the insertion units 3 or the removal units 25 are not moved by a pivot movement but a linear movement into the open injection mold 4.

The injection molds 4 can be arranged horizontally, vertically but also inclined within the injection molding machine. Accordingly, other units of the machine then have appropriately adjusted positions.

What is claimed is:

1-29. (canceled)

30. An injection molding machine for producing shaped plastic parts, the injection molding machine comprising:
at least one injection mold;
at least one removal unit with which shaped plastic parts are removed from the at least one injection mold;
wherein the shaped plastic parts are put down in a controlled way while the at least one injection mold is in a closed position.

31. The injection molding machine according to claim 30, comprising at least one putting-down unit, wherein the at least one removal unit transfers the shaped plastic parts to the at least one putting-down unit.

32. The injection molding machine according to claim 31, comprising at least one receptacle, wherein the putting-down unit places the shaped plastic parts into the at least one receptacle.

33. The injection molding machine according to claim 31, wherein the at least one putting-down unit has two arms positioned angularly relative to one another, wherein the two arms have suction holders for the shaped plastic parts.

34. The injection molding machine according to claim 33, wherein the two arms are positioned at a right angle to one another.

35. The injection molding machine according to claim 33, wherein the putting-down unit is pivotable about a pivot axle.

36. The injection molding machine according to claim 35, wherein the pivot axle is positioned at a 45 degree angle relative to the two arms, respectively.

37. The injection molding machine according to claim 30, wherein the at least one removal unit is rotatable about a first axle.

38. The injection molding machine according to claim 30, wherein the at least one removal unit has a second axle on which at least one suction holder for the shaped plastic parts is fixedly secured.

39. The injection molding machine according to claim 38, wherein the second axle is parallel to the first axle.

40. The injection molding machine according to claim 39, wherein the first and second axles are oppositely driven during pivoting of the at least one removal unit.

41. The injection molding machine according to claim 37, comprising at least one insertion unit.

42. The injection molding machine according to claim 41 wherein with the at least one insertion unit inserts labels into the at least one injection mold when the at least one injection mold is in an open position.

43. The injection molding machine according to claim 42, wherein the at least one insertion unit has a pivot shaft.

44. The injection molding machine according to claim 43, wherein the pivot shaft is positioned parallel to the first axle of the at least one remote unit.

45. The injection molding machine according to claim 42, wherein the at least one insertion unit and the at least one removal unit are arranged on opposite sides of the at least one injection mold.

46. The injection molding machine according to claim 45, wherein the at least one insertion unit inserts labels into the at least one injection mold almost simultaneously to removal of the shaped plastic parts from the at least one injection mold.

47. The injection molding machine according to claim 41, comprising at least one transfer unit, wherein the at least one insertion unit receives the labels from the at least one transfer unit.

48. The injection molding machine according to claim 47, further comprising a stand, wherein the at least one transfer unit is arranged on the stand.

49. The injection molding machine according to claim 48, wherein the stand has two opposed sides and wherein at least one transfer unit each is provided on the two opposed sides.

50. The injection molding machine according to claim 49, wherein two of said at least one transfer unit are provided on each of the two opposed sides, wherein a first one of said two transfer units transfers a label to the at least one insertion unit and a second one of the two transfer units simultaneously removes a label from at least one magazine.

51. The injection molding machine according to claim 41, wherein the at least one insertion unit has a receiving head on which the labels are secured by vacuum, respectively.

52. The injection molding machine according to claim 51, wherein the receiving head has sidewalls and an end face, wherein the sidewalls and the end face have vacuum openings through which suction air acts on the labels received on the receiving head, respectively.

53. The injection molding machine according to claim 51, wherein the labels each are automatically wound in a cup shape onto the receiving head when applying vacuum through the vacuum openings.

54. The injection molding machine according to claim 41, further comprising a linear unit, wherein the at least one removal unit transfers the shaped plastic parts to the linear unit.

55. The injection molding machine according to claim 54, wherein the at least one removal unit transfers the shaped plastic parts to the linear unit while the at least one injection mold is in the closed position.

56. The injection molding machine according to claim 54, wherein the linear unit has at least two suction holders.

57. The injection molding machine according to claim 54, wherein the linear unit transfers the labels to the at least insertion unit while the at least one injection mold is in the closed position.

58. The injection molding machine according to claim 30, wherein the at least one injection mold has mold parts with a female mold and a male mold, wherein the mold parts are exchangeable.
